(19) United States
(12) Patent Application Publication
(10) Pub. No.: US 2025/0158457 A1
(43) Pub. Date: May 15, 2025

(54) DRIVE

(71) Applicant: SEW-EURODRIVE GMBH & CO. KG, Bruchsal (DE)

(72) Inventor: Jan MILDENBERGER, Malsch (DE)

(73) Assignee: SEW-EURODRIVE GMBH & CO. KG, Bruchsal (DE)

(21) Appl. No.: 18/838,810

(22) PCT Filed: Jan. 23, 2023
(86) PCT No.: PCT/EP2023/051589

§ 371 Date: Aug. 15, 2024

(30) Foreign Application Priority Data
Feb. 15, 2022 (DE) 10 2022 000 573.5

(51) Int. Cl. H02K 1/18; H02K 5/15; H02K 5/22; H02K 11/33

(52) U.S. Cl. CPC H02K 1/18; H02K 5/15; H02K 5/225; H02K 11/33

(57) ABSTRACT

A drive, e.g., an electric motor, includes a stator housing and an adapter connected to the stator housing. The stator housing is connected to an end shield that receives a bearing of a rotor shaft of the drive, and the adapter is connected on its side facing away from the stator housing to a lower part that, with a cover part fitted on the lower part, forms a connection box of the drive. The adapter is produced as a cast part made of metal, and a circumferential depression is formed on the adapter on the side of the adapter facing the stator housing. The depression has a bottom region and two wall regions adjoining the bottom region. An injection molded part is received in the depression and rests against a surface region of the stator housing, and the surface region is unmachined.

### FIELD OF THE INVENTION

The present invention relates to a drive, e.g., an electric motor.

### BACKGROUND INFORMATION

In certain conventional system, a drive is supplied energy electrically.

A connection box for an electric motor is described in German Patent Document No. 10 2009 008 703.

A series of electric motors is described in German Patent Document No. 10 2004 063 920.

### SUMMARY

Example embodiments of the present invention provide a drive with a high degree of protection.

According to example embodiments of the present invention, a drive, e.g., an electric motor, includes a stator housing and an adapter connected to the stator housing, e.g., a frame-shaped adapter, e.g., a frame adapter or frame. The stator housing is connected to an end shield that receives a bearing of a rotor shaft of the drive, e.g., for rotatably bearing the rotor shaft, and the adapter is connected on its side facing away from the stator housing to a lower part that, with a cover part fitted on the lower part, forms a connection box of the drive. The adapter is produced as a cast part made of metal and/or the stator housing is produced as a cast part made of metal, and a circumferential depression on the adapter, e.g., a complete and/or closed circumferential depression, is formed on the side of the adapter facing the stator housing. The depression has a bottom region and two wall regions adjoining the bottom region, and an injection molded part is received in the depression and rests against a surface region of the stator housing, e.g., such that the injection molded part is elastically deformed. The surface region is unmachined, that is, is an unmachined unfinished casting surface region, and/or the depression, e.g., the bottom region and the two wall regions, is or are unmachined, that is, each is an or are unmachined unfinished casting surface regions.

Thus, the injection molded part functions as a damping part for vibrations of the adapter against the stator housing. Thus, the projecting part of the adapter is damped. Although the injection molded part, similar to a seal, is arranged in a depression, similar to a groove, the injection molded part does not seal because, in contrast to the groove, the groove bottom and the wall regions of the groove are unmachined, that is, are unfinished casting surface areas. Sealing tightness is not possible due to the roughness of the unfinished casting surface areas. However, it is possible to dampen vibrations of the adapter against the stator housing. The drive is thus provided with a high degree of protection because, in addition to the seals, the injection molded part rests closely against the stator housing and adapter such that correspondingly large dirt particles are prevented from penetrating into the region between stator housing and adapter.

According to example embodiments, the adapter and the lower part are arranged in one piece, e.g., integrally, e.g., as a cast part. Thus, cost-effective production is possible and it is not necessary to machine the seat and the contact surface of the injection molded part. Thus, the injection molded part rests against unfinished casting surface regions. For example, this does not lead to a high degree of sealing tightness, but damping of vibrations is attainable.

According to example embodiments, cable bushings for passing through electrical power supply lines and data bus lines are arranged in the lower part. Thus, the lower part, together with the cover part, forms the connection box and the power supply lines lead through the cable bushings to connection devices, e.g., connection terminals, that are received in the lower part.

According to example embodiments, the injection molded part is a plastic injection molded part. Thus, this permits cost-effective production.

According to example embodiments, the injection molded part is an elastomer. Thus, damping of vibrations of the region of the adapter projecting beyond the stator housing is made possible.

According to example embodiments, the respective unfinished casting surface region is not machined. Thus, cost-effective production is possible.

According to example embodiments, the surface region is planar, and the normal direction for this planar surface region has a first angle to a first direction, the magnitude of which is between 10° and 80°. The first direction is oriented parallel to the direction of a bore axis of a threaded bore of the end shield or stator housing, and a connecting screw is screwed into the threaded bore, which presses the adapter toward the stator housing. For example, the connecting screw is passed through a sealing ring that rests against the stator housing. Thus, the pressing force generated by screws has a normal component and a component perpendicular thereto, so that only the two normal components result in an effective connection with a correspondingly inversely inclined contact surface. This provides for secure fastening of the adapter to the stator housing and/or end shield. Slipping along the contact surface can be prevented. Overall this increases the service life because the drive is adapted to be more stable against the effects of outside forces than if the normal direction of the contact surface was oriented parallel to the first direction, e.g., that is, to the pressing force direction of the screws.

According to example embodiments, a first of the two wall regions is shorter than the second of the two wall regions, e.g., along the first direction. Thus, the shorter wall region can be arranged to be stiffer, and, thus, a high degree of stability can be achieved.

According to example embodiments, the adapter is tapered toward the stator housing, e.g., such that the maximum surface area surrounded by the adapter in a plane whose normal direction is parallel to the first direction, e.g., the fitting direction, increases monotonically as the distance of the plane from the stator housing increases. Thus, the connection box can be wider than the connection region of the adapter on the stator housing.

According to example embodiments, the injection molded part rests against a further surface region of the stator housing, the further surface region is planar, and the normal direction of this planar further surface region has a second angle to the first direction, which angle is inverted with respect to the first angle, e.g., thus, has the opposite sign of the first angle. The first direction is oriented parallel to the direction of a bore axis of a threaded bore of the end shield or stator housing, and a connecting screw is screwed into the threaded bore, which presses the adapter towards the stator housing. Thus, the contact surface of the further surface region is inclined in the opposite direction to the inclination of the contact surface of the first surface area. This permits the adapter to rest securely against the stator housing.

According to example embodiments, the end shield and/or the stator housing has a continuous recess through which an electrical line is guided from the interior of the stator housing, e.g., from a stator winding arranged in the stator housing, to a connection device, e.g., a connection terminal, that is received in the lower part. A flat gasket is pressed by a fastening device against the end shield and/or the stator housing, and the electrical line is passed through an opening, e.g., a cross-like through-slotted region of the flat gasket. For example, the recess opens into the opening and/or the fastening device is a metal sheet part that is pressed against the flat gasket by two screws, and the screws are screwed into threaded bores of the end shield or stator housing. Thus, the electrical line can be led out of the interior of the stator in a sealed manner.

According to example embodiments, the cover part has a signal electronics element that is connected via a plug-in connection to a power electronics element that functions as an inverter and supplies the stator winding via at least the electrical line. Thus, a power electronics element and a signal electronics element can be arranged in the connection box, and the signal electronics element can be cooled via the cover part and the power electronics element can be connected to the lower part in a thermally conductive manner. The signal electronics element can be electrically connected to the power electronics element via a plug-in connector. Thus, power electronics element and signal electronics element can be operated at different temperature levels. An air cushion can be created between the lower part and the stator housing via the injection molded part and acts as a thermal barrier between stator housing and power electronics element. The injection molded part also functions as a partial thermal barrier between adapter and stator housing. In this manner, the stator can be cooled more independently of the power electronics element, e.g., with respect to the environment.

According to example embodiments, tab regions are formed on the injection molded part, each of which projects through a respective interruption in the wall region, e.g., the shorter of the two wall regions, and each respective tab region is formed wider on the side of the wall region facing away from the depression, e.g., the shorter of the two wall regions, e.g., for securing the injection molded part in the adapter in a positive fit. Each respective tab region is elastically clamped in the respective interruption in the wall region, e.g., the shorter of the two wall regions. Thus, the injection molded part is secured in a positive fit, with the tab regions being clamped, and thus elastically deformed, only in the region of the interruption. The inwardly projecting widened part of the tab region is not elastically deformed, e.g., is thus spaced apart from the stator housing and end shield, especially since this part projects into an open space region, e.g., within the adapter.

According to example embodiments, the injection molded part in the depression is limited on the one hand by the adapter and on the other by the stator housing and/or end shield, e.g., for preventing it from slipping out in or against the first direction, e.g., the fitting direction. Thus, the injection molded part is secured in a positive fit.

According to example embodiments, the wall regions are also arranged circumferentially, e.g., with the depression. Thus, the wall regions, together with the depression, are arranged circumferentially around the outer edge of the adapter. Thus, the largest possible surface area is enclosed and can be protected. In addition, the damping effect of the injection molded part is therefore optimized due to the greatest possible lever action.

According to example embodiments, the wall regions are spaced apart from the stator housing and/or end shield such that the injection molded part rests against the stator housing or end shield, but not the adaptor and its wall regions. Thus, the injection molded part rests against the stator housing for damping vibrations of the adapter to the stator housing, but not against the adaptor and its wall regions.

Further features and aspects of example embodiments of the present invention are described in greater detail below with reference to the appended schematic Figures.

### BRIEF DESCRIPTION OF THE DRAWINGS

FIG. 1 is an exploded side elevation view of a drive with injection molded part 2 and adapter 3 provided for receiving this injection molded part 2.

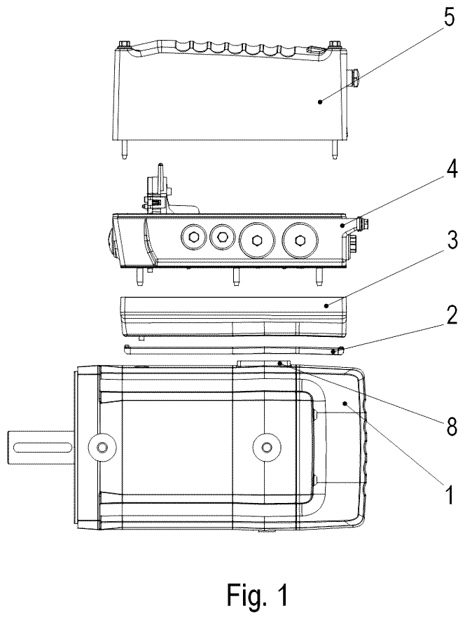

FIG. 2 is an enlarged view of a segment of the injection molded part 2 with tab region 9.

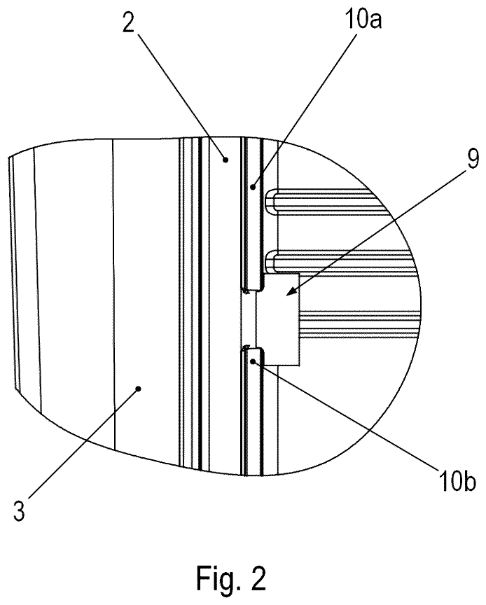

FIG. 3 is a top view with a frame-like adapter 3.

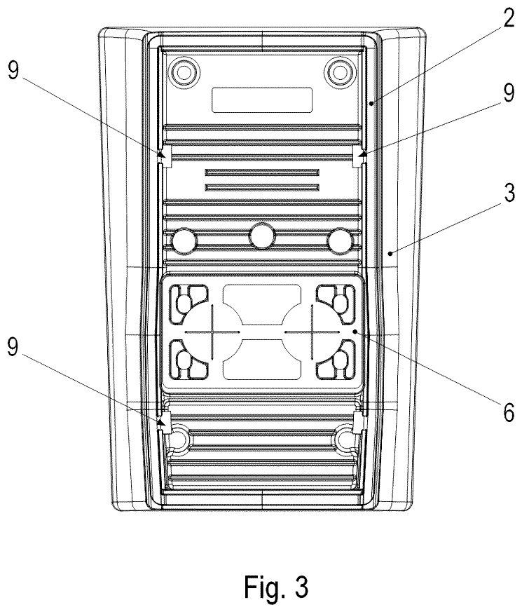

FIG. 4 is the top view with the adapter 3 hidden, but with the injection molded part 2 still present.

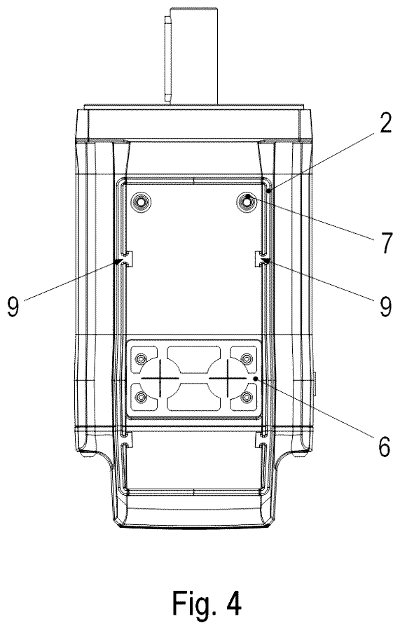

FIG. 5 is a perspective view of the drive.

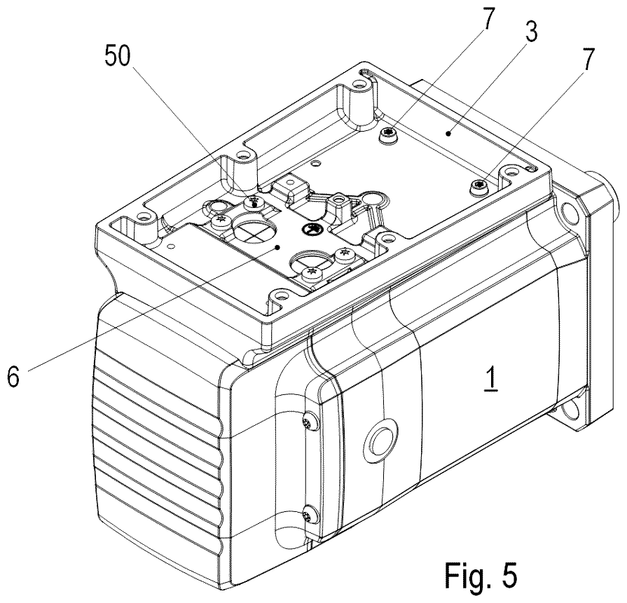

FIG. 6 is a top view of the drive.

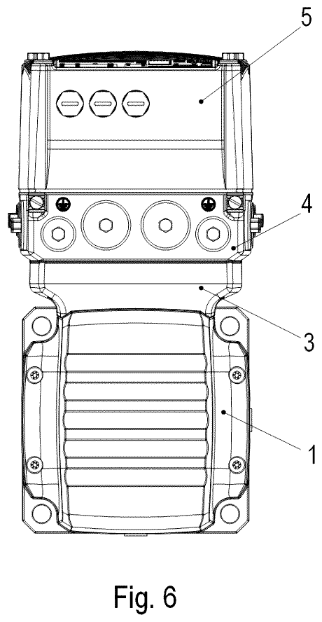

FIG. 7 is a cross-sectional view of the drive.

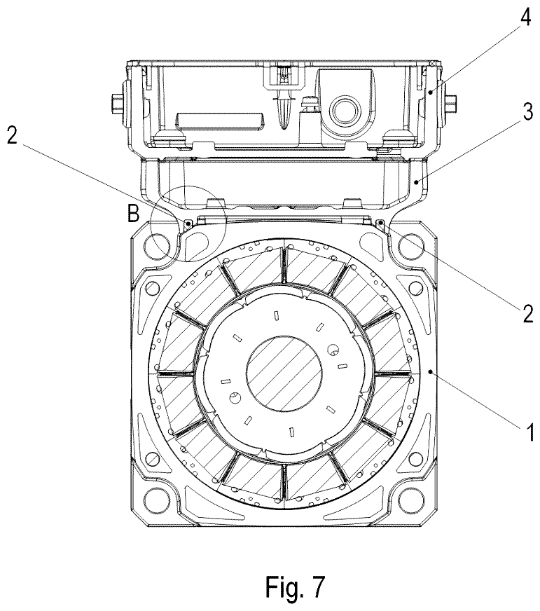

FIG. 8 is an enlarged view of a segment of FIG. 7.

### DETAILED DESCRIPTION

As schematically illustrated in the Figures, the drive has an electric motor that has a stator housing 1 that surrounds the stator winding of the electric motor, forming a housing.

On each axial side, the electric motor has an end shield for receiving a respective bearing for rotatably mounting the rotor shaft.

The axial direction is parallel to the rotational axis of the rotor shaft.

Fitted on an end shield 8 is a frame-like adapter on which a lower part of a connection box is fitted, so that the adapter 3 is interposed between the lower part 4 and the end shield 8.

A cover plate 5 is fitted on the lower part and includes a power electronics element and a signal electronics element.

The stator winding is supplied power from the power electronics element, which has an inverter, the power semiconductor switches of which receive their control signals from the signals electronics element. Thus, the electric motor can be controlled or regulated, e.g., in terms of the speed or torque of the electric motor.

Connection devices, e.g., connection terminals, for power supply lines are arranged in the lower part 4.

The adapter 3 projects axially from the axial region covered axially by the end shield. Thus, it projects beyond the stator housing 1, at least in part.

The end shield 8 and/or the stator housing 1 has or have continuous recesses through which electrical lines, e.g., winding wire ends of the stator winding, from the interior of the stator housing 1 to a connection device, e.g., a connection terminal, received in the lower part 4.

A flat gasket 6 is fitted on the end shield 8 and has two cross-slotted through regions spaced apart from one another through which the electrical lines are guided. The flat gasket is, for example, pressed by metal sheet pieces against the end shield, and screwheads of screws screwed into the threaded bores of the stator housing press the flat gasket 6 against the end shield 8.

Thus, the electrical lines are passed through the flat gasket 6 and thus the interior of the stator is sealed from the interior of the connection box and from the interior surrounded by the adapter 3.

The injection molded part 2 is received in a circumferential depression on the adapter 3 and is pressed against the surface of the end shield 8 and/or the stator housing 1. The end shield 8 and the stator housing 1 are each arranged as cast parts.

The surface of the stator housing 1 is unmachined in the region in which the injection molded part 2 contacts the surface. Thus, the surface roughness in this region is that of an unfinished cast part. Because of this, even if the injection molded part 2 is formed of an elastomer, e.g., a plastic, it is not possible to attain a high degree of sealing tightness, that is, for example, a high degree of protection.

Nevertheless, a seal against larger particles is provided.

Cable bushings for power supply lines, e.g., rotary current lines and data bus lines, as well as low-voltage lines, are arranged on the sides of the lower part 4.

The circumferential depression on the adapter 3 is also unmachined and thus provided with a roughness like that of an unfinished cast part.

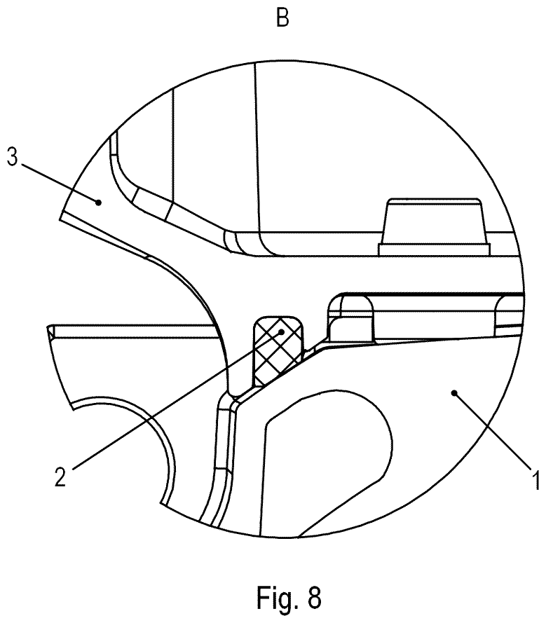

As illustrated in FIG. 8, the depression has a bottom region and two wall regions, similar to a groove that has a groove bottom and two groove walls. A first of the two wall regions is shorter than the other of the wall regions.

The surface region contacted by the injection molded part 2 on the stator housing 1 is planar; however the normal direction of the planar surface region is not parallel to the fitting direction of the cover part 5 onto the lower part 4 and to the fitting direction of the lower part 4 onto the adapter 3.

The fitting direction is the direction in which the lower part 4 is fitted onto the adapter 3 and/or in which the adapter 3 is fitted onto the end shield 8 and/or in which the cover part 5 is fitted onto the lower part 4. The fitting direction is, for example, parallel to the line connecting the center of gravity of the lower part to the center of gravity of the frame 3 and/or to the cover part 5.

Due to this orientation of the contact surface of the stator housing 1 or the end shield 8, which is at an angle to the fitting direction, that is, for example, not vertical, the wall areas are of different lengths.

The injection molded part 2 is inserted into the circumferential depression. The wall regions are thus also arranged circumferentially, in which the shorter wall region has an interruption at several points, through each of which interruptions a tab region 9 formed on the injection molded part 2 projects. Each of these tab regions 9 is widened such that the injection molded part 2 is clamped elastically in the respective interruption at the respective points and is held in a positive fit on the shorter wall region by the widened configuration of the tab region 9 in the interior surrounded by the adapter 3.

Slipping out in or against the fitting direction is prevented in that the injection molded part is limited in the depression on the one side by the adapter 3 and on the other side by the stator housing 1.

In this manner, the injection molded part 2 dampens vibrations of the region of the adapter 3 projecting beyond the stator housing 1. Due to the inclined configuration of the contact surface on the stator housing 1, not only are vibrations oriented in the fitting direction dampened, but also vibrations transverse thereto. Thus, the injection molded part 2 functions as a damping part and also prevents impurities from penetrating into the adapter 3.

From the external environment to the interior surrounded by the stator housing 1, impurities such as grains of sand, dust, etc., must overcome not only the injection molded part 2, but also the flat gasket 6.

The region of the adapter 3 projecting beyond the stator housing 1 and/or the lower part 4 with the cover part 5 fitted thereon is additionally secured with screws that are screwed into threaded bores of the stator housing. The screws project through the sealing rings 7 so that the interior of the stator is sealed from the interior of the frame 3 and/or the connection box.

Thus, it is possible to attain improvement in the stability and/or stiffness due to the screws. However, the adapter 3 does not rest directly against stator housing 1, so that the injection molded part 2 acts as a damping part.

The adapter 3 is tapered towards the stator housing 1. Thus, the maximum surface area surrounded by the adapter 3 in a plane the normal direction of which is parallel to the fitting direction increases monotonically as the distance from the stator housing 1 increases.

In further exemplary embodiments, the adapter 3 and the lower part 4 are arranged in one piece, e.g., integrally. However, an adapted partial region must be provided for a stator housing 1 of a specific size.

### LIST OF REFERENCE NUMERALS

1 Stator housing
2 Injection molded part
3 Frame-like adapter
4 Lower part
5 Cover part
6 Flat gasket
7 Sealing ring
8 End shield
9 Tab region
10 Groove wall
50 Screw

1-15. (canceled)

16. A drive, comprising:
an end shield that receives a bearing of a rotor shaft of the drive;
a stator housing connected to the end shield; and
an adapter connected to the stator housing and connected on a side facing away from the stator housing to a lower part that, with a cover part fitted on the lower part, forms a connection box of the drive, the adapter and/or the stator housing being arranged as a cast part made of metal;
wherein the adapter includes a circumferential depression, a complete circumferential depression, and/or a closed circumferential depression arranged on a side of the adapter facing the stator housing, the depression including a bottom region and two wall regions adjoining the bottom region;
wherein an injection molded part is received in the depression and rests against a surface region of the stator housing; and
wherein the surface region and/or the depression is unmachined.

17. The drive according to claim 16, wherein the adapter is frame-shaped, arranged as an frame adapter, and/or arranged as a frame, the bearing rotatably supporting the rotor shaft of the drive.

18. The drive according to claim 16, wherein the surface region, the depression, the bottom region, and/or the two wall regions are arranged as unmachined, unfinished casting surface regions.

19. The drive according to claim 16, wherein the adapter and the lower part are arranged in one piece, integrally, and/or as a cast part.

20. The drive according to claim 16, wherein cable bushings adapted for passing through electrical power supply lines and data bus lines are arranged in the lower part.

21. The drive according to claim 16, wherein the injection molded part is arranged as a plastic injection molded part.

22. The drive according to claim 16, wherein the injection molded part is formed of an elastomer.

23. The drive according to claim 16, wherein the surface region is planar, and a normal direction of the planar surface region has a first angle to a first direction, the magnitude of which is between 10° and 80°, the first direction being oriented parallel to a direction of a bore axis of a threaded bore of the end shield or stator housing, a connecting screw being screwed into the threaded bore and pressing the adapter toward the stator housing.

24. The drive according to claim 23, wherein the connecting screw passes through a sealing ring that rests against the stator housing.

25. The drive according to claim 16, wherein a first one of the two wall regions is shorter than a second one of the two wall regions.

26. The drive according to claim 23, wherein the adapter is tapered toward the stator housing.

27. The drive according to claim 26, wherein a maximum surface area surrounded by the adapter in a plane having a normal direction parallel to the first direction increases monotonically as distance of the plane from the stator housing increases.

28. The drive according to claim 23, wherein the injection molded part rests against a further surface region of the stator housing, the further surface region being planar and having a normal direction having a second angle to the first direction that is inverted with respect to and/or has an opposite sign as the first angle, the first direction oriented parallel to the direction of a bore axis of a threaded bore of the end shield or stator housing, a connecting screw being screwed into the threaded bore and pressing the adapter towards the stator housing.

29. The drive according to claim 16, wherein the end shield and/or the stator housing has a continuous recess through which an electrical line is guided from an interior of the stator housing to a connection device that is received in the lower part, a flat gasket being pressed by a fastening device against the end shield and/or the stator housing, the electrical line passing through an opening of the flat gasket.

30. The drive according to claim 29, wherein the recess opens into the opening and/or the fastening device is a metal sheet part that is pressed against the flat gasket by two screws that are screwed into threaded bores of the end shield or stator housing.

31. The drive according to claim 16, wherein the cover part includes a signal electronics component that is connected via a plug-in connection to a power electronics component that is arranged as an inverter and supplies the stator winding via an electrical line.

32. The drive according to claim 16, wherein tab regions are arranged on the injection molded part, each tab region projecting through a respective interruption in the wall region, each tab region being wider on a side of the wall region facing away from the depression, each tab region being elastically clamped in a respective interruption in the wall region.

33. The drive according to claim 16, wherein the injection molded part in the depression is limited by the adapter and by the stator housing and/or end shield.

34. The drive according to claim 16, wherein the wall regions are arranged circumferentially.

35. The drive according to claim 16, wherein the wall regions are spaced apart from the stator housing and/or the end shield.

36. The drive according to claim 35, wherein the injection molded part rests against the stator housing and/or the end shield.

37. The drive according to claim 36, wherein the injection molded part does not rest against the adaptor or the wall regions.
